(19) United States
(12) Patent Application Publication
(10) Pub. No.: US 2013/0234928 A1
(43) Pub. Date: Sep. 12, 2013

(54) APPARATUS AND METHOD FOR CONTROLLING SCREEN

(71) Applicant: ELECTRONICS AND TELECOMMUNICATIONS RESEARCH INSTITUTE, Daejeon (KR)

(72) Inventor: Chi Yoon JEONG, Daejeon (KR)

(73) Assignee: Electronics and Telecommunications Research Institute, Daejeon (KR)

(21) Appl. No.: 13/712,849

(22) Filed: Dec. 12, 2012

(30) Foreign Application Priority Data
Mar. 9, 2012 (KR) 10-2012-0024343

(51) Int. Cl. G06F 3/01

(52) U.S. Cl. CPC G06F 3/01
USPC 345/156

(57) ABSTRACT

An apparatus for controlling a screen includes a data reception unit configured to receive data and one or more events to be displayed on a screen; and a user input unit configured to provide input information attributable to manipulation of a user input device. Further, the apparatus for controlling the screen includes a screen control unit configured to determine whether to update or switch the screen based on the events and the input information.

### CROSS-REFERENCE TO RELATED APPLICATION(S)

The present invention claims priority of Korean Patent Application No. 10-2012-0024343, filed on Mar. 9, 2012, which is incorporated herein by reference.

### FIELD OF THE INVENTION

The present invention relates to updates of a screen; and, more particularly, to an apparatus and method which are capable of effectively transferring important information without distracting a user's attention when updating or switching a screen, which requires the user's continuous monitoring, in order to display newly input data or renew the information of the screen.

### BACKGROUND OF THE INVENTION

Methods of updating the information of a monitoring screen that requires a user's continuous monitoring may be classified into methods of using a timer, methods of using event data, and methods of using both a timer and event data.

The methods of updating a monitoring screen using a timer are configured to operate a timer using a user-set time and update a screen when the set time has elapsed. These methods may be classified into a method of using a single timer for an overall screen and a method of using independent timers for respective components of a screen. The methods of using a timer are problematic in that a screen is updated at a set cycle even when important data occurs during the set cycle. Furthermore, the methods of using a timer are problematic in that a screen is updated before a user interprets information of a screen when a set update cycle is shorter than the time it takes to do so.

The methods of updating a monitoring screen using event data are configured to update a screen whenever an event is received, or to update a screen when N events have been received. These methods are advantageous in that a user can view information about an important event almost in real time when an important event occurs. However, these methods are problematic in that a screen update cycle is shortened when a large amount of event data occurs and the screen update cycle is lengthened when an event rarely occurs.

The methods of using both a timer and event data are configured to update a screen at the screen update cycle of a timer and a screen update cycle based on the reception of an event. These methods are advantageous in that a user can view information about an important event in real time when the important event occurs and an update cycle is not lengthened even when an event rarely occurs.

The above-described conventional methods have the problem of changing a screen while a user is interpreting information of the screen or the problem of preventing an important event from being viewed because of an unimportant event because these conventional methods are configured to mechanically update a monitoring screen without taking into consideration a user's perception ability, the pattern of the user's use, and the importance of events.

### SUMMARY OF THE INVENTION

In view of the above, the present invention provides an apparatus and method that are configured to set an update cycle by analyzing user behavioral pattern information and the importance of events, thereby being able to effectively provide important information to a user without distracting a user's attention when updating or switching a monitoring screen.

In accordance with a first aspect of the present invention, there is provided an apparatus for controlling a screen, including: a data reception unit configured to receive data and one or more events to be displayed on a screen; a user input unit configured to provide input information attributable to manipulation of a user input device; and a screen control unit configured to determine whether to update or switch the screen based on the events and the input information.

Further, the screen control unit may comprise an event prioritization module configured to determine event-related characteristic and statistical information based on a number of events having been received via the data reception unit for a preset period and a percentage of important events distributed among the events; a user behavioral pattern learning module configured to determine user behavioral pattern-related characteristic and statistical information based on an average time it takes for a user to view each screen and its standard deviation, an average time it takes to switch between screens and its standard deviation, or a sequence frequency at which the screen is changed, by analyzing the input information attributable to the manipulation of the user input device; and a screen update determination module configured to determine whether to update or switch the screen based on the event-related characteristic and statistical information and the user behavioral pattern-related characteristic and statistical information.

Further, the apparatus may further comprise a timer setting unit configured to provide an interface that allows a timer to be set for each screen or each component of each screen and to provide information about the timer set via the interface to the screen control unit.

The screen control unit may further comprise a user-set timer module configured to determine operated timer-related characteristic and statistical information as the timer set via the interface is operated; and the screen update determination module may determine whether to update or switch the screen based on the event-related characteristic and statistical information, the user behavioral pattern-related characteristic and statistical information, and the timer-related characteristic and statistical information.

Further, the screen update determination module may determine whether to update or switch the screen using a machine learning pattern recognition method that uses the event-related characteristic and statistical information, the user behavioral pattern-related characteristic and statistical information, and the timer-related characteristic and statistical information as a feature vector.

The timer-related characteristic and statistical information may be one of a set value of the timer, a time remaining to reach the set value, and completion or incompletion of the operation of the timer.

Further, the event-related characteristic and statistical information may be one of the number of events having been received via the data reception unit, history information related to numbers of events previously received, and statistical information related to importance of the events having been currently received.

The user behavioral pattern-related characteristic and statistical information may be one of an average time it takes for a user to view a current screen and its standard deviation, a similarity between a pattern of current user-input information and a pattern of previous user-input information, and statistical information related to screens that have been selected by a user after a current screen was displayed.

Further, the screen update determination module may determine whether to update or switch the screen using a machine learning pattern recognition method that uses the event-related characteristic and statistical information and the user behavioral pattern-related characteristic and statistical information as a feature vector.

In accordance with a second aspect of the present invention, there is provided a method for controlling a screen, including: receiving data and one or more events to be displayed on a screen; generating input information attributable to manipulation of a user input device; and determining whether to update or switch the screen based on the events and the input information.

Further, said determining whether to update or switch the screen may comprise computing event-related characteristic and statistical information based on a number of events having been received for a preset period and a percentage of important events distributed among the events; computing user behavioral pattern-related characteristic and statistical information based on an average time it takes for a user to view each screen and its standard deviation, an average time it takes to switch between screens and its standard deviation, or a sequence frequency at which the screen is changed, by analyzing the input information attributable to the manipulation of the user input device; and determining whether to update or switch the screen based on the event-related characteristic and statistical information and the user behavioral pattern-related characteristic and statistical information.

Further, the method may further comprise providing an interface that allows a timer to be set for each screen or each component of each screen, and said determining whether to update or switch the screen may comprise extracting operated timer-related characteristic and statistical information as the timer set via the interface is operated; and determining whether to update or switch the screen based on the event-related characteristic and statistical information, the user behavioral pattern-related characteristic and statistical information, and the timer-related characteristic and statistical information.

Further, said determining whether to update or switch the screen may comprise determining whether to update or switch the screen using a machine learning pattern recognition method that uses the event-related characteristic and statistical information, the user behavioral pattern-related characteristic and statistical information, and the timer-related characteristic and statistical information as a feature vector.

Furthermore, the timer-related characteristic and statistical information may be one of a set value of the timer, a time remaining to reach the set value, and completion or incompletion of the operation of the timer.

The event-related characteristic and statistical information may be one of the number of events having been received via the data reception unit, history information related to numbers of events previously received, and statistical information related to importance of the events having been currently received.

Further, the user behavioral pattern-related characteristic and statistical information may be one of an average time it takes for a user to view a current screen and its standard deviation, a similarity between a pattern of current user-input information and a pattern of previous user-input information, and statistical information related to screens that have been selected by a user after a current screen was displayed.

Furthermore, said determining whether to update or switch the screen may comprise determining whether to update or switch the screen using a machine learning pattern recognition method that uses the event-related characteristic and statistical information and the user behavioral pattern-related characteristic and statistical information as a feature vector.

In accordance with the present invention, it is possible to effectively provide important information to a user without distracting a user's attention because the present invention is configured to automatically update or switch a screen by collectively considering information including the time it takes for the user to interpret the screen, the characteristics of data having currently been received, and a user-set timer.

Furthermore, it is possible to more rapidly provide important information to a user because the present invention uses a method of shortening a screen update cycle when an important event occurs and automatically switching the screen from a current screen to another important screen when the current screen has no change in data, rather than a conventional method of switching a screen when a set time has elapsed or a set number of events have occurred.

Moreover, it is possible to overcome the problem of distracting a user's attention due to the update of a screen during the viewing of the screen because the present invention takes into consideration the user's ability to interpret information based on the fact that the time it takes for a human to interpret information displayed on a screen varies.

### BRIEF DESCRIPTION OF THE DRAWINGS

The objects and features of the present invention will become apparent from the following description of embodiments given in conjunction with the accompanying drawings, in which:

FIG. 1 is a block diagram showing an apparatus for controlling a screen in accordance with an embodiment of the present invention;

FIG. 2 is a flow chart showing a process of updating or switching a screen in accordance with the embodiment of the present invention; and

FIG. 3 is a diagram illustrating the difference between a conventional screen update method and a method for controlling the screen in accordance with the embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings so that they can be readily implemented by those skilled in the art.

An apparatus and method for controlling a screen,which are capable of effectively transferring important information without distracting a user's attention when updating or switching a screen will be described below with reference to the accompanying drawings.

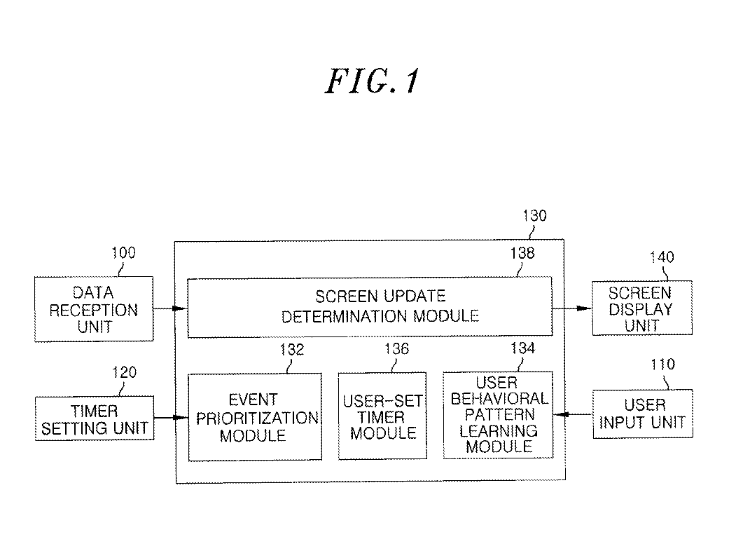

FIG. 1 is a block diagram showing an apparatus for controlling a screen in accordance with an embodiment of the present invention. The apparatus for controlling the screen may include a data reception unit 100, a user input unit 110, a timer setting unit 120, a screen control unit 130, and a screen display unit 140.

The data reception unit 100 may receive data and one or more events to be displayed on a screen via the screen display unit 140. That is, the data reception unit 100 may receive monitoring data, alarm data, etc. while operating in conjunction with a network management system, an integrated security management system, etc. over a network, and provide the data to the screen control unit 130.

The user input unit 110 may receive input information attributable to the manipulation of a user input device. Here, examples of the user input device include a keyboard, a mouse, and a touch panel. The user input unit 110 may receive input information attributable to the manipulation of a keyboard, a mouse, or a touch panel in response to data displayed on the screen, and provide the input information to the screen control unit 130.

The timer setting unit 120 may provide an interface for allowing a timer for each screen or each screen component to be set, and provide information about the timer set via the interface to the screen control unit 130.

The screen control unit 130 may determine whether to update or switch the screen displayed via the screen display unit 140 by considering the input information, an event, and information about the timer. For this purpose, the screen control unit 130 may include an event prioritization module 132, a user behavioral pattern learning module 134, a user-set timer module 136, and a screen update determination module 138.

The event prioritization module 132 is means for generating information related to the number of events for each preset period, for example, per second, and the percentage of important events distributed among the events. The event prioritization module 132 may determine event-related characteristic and statistical information based on the number of events and the percentage of important events distributed among the events. For example, a network management system and an integrated security management system receive alarm data over a network, and this alarm data represents danger or importance. Accordingly, the event prioritization module 132 may compute event-related characteristic and statistical information using the percentage of the distributed events based on the number of events having been currently received and the danger or importance of a current event, and provide the computed information to the screen update determination module 138. Here, the event-related characteristic and statistical information may be the number of events having been currently received, history information related to the numbers of events previously received, or statistical information related to the importance of the events having been currently received.

A conventional screen update method based on the number of events is problematic in that when a screen update cycle is set based on 100 events, a screen is updated late if 10 important events are received and then no more events are received. In contrast, as described above, since the embodiment of the present invention can determine a screen update or switch cycle by determining the importance of events, the embodiment of the present invention can more rapidly provide important information to a user because the screen update or switch cycle can be shortened when many important event occur.

The user behavioral pattern learning module 134 may analyze a current screen and input information attributable to the manipulation of a user input device such as a keyboard, a mouse, or a touch screen, extract user behavioral pattern-related characteristic and statistical information such as the average time it takes for a user to view a screen and its standard deviation, the average time it takes to switch between screens and its standard deviation, and a sequence frequency at which a screen is changed via a user input device, and provide the user behavioral pattern-related characteristic and statistical information to the screen update determination module 138. Here, the user behavioral pattern-related characteristic and statistical information may be the average time it takes for a user to view a current screen and its standard deviation, the similarity between the pattern of current user-input information and the pattern of previous user-input information, and statistical information related to screens that have been selected by a user after the current screen was displayed.

The user behavioral pattern-related characteristic and statistical information may be used to consider the fact that the time it takes for a user to analyze the information of a screen varies in accordance with the screen when determining whether to update or switch a screen.

The user-set timer module 136 is a module that operates in conjunction with the timer setting unit 120. When a separate timer operates for each screen or for each screen component, corresponding information may be sent to the screen update determination module 138 after the time set on the timer has elapsed. That is, the user-set timer module 136 may provide set timer-related characteristic and statistical information to the screen update determination module 138 after the timer set by the timer setting unit 120 has operated. Here, the timer-related characteristic and statistical information may be the set value of a current timer, the time remaining to reach the set value, and timer completion or incompletion.

The screen update determination module 138 may determine to update or switch a screen by considering event-related characteristic and statistical information, user behavioral pattern-related characteristic and statistical information, and timer-related characteristic and statistical information. That is, the screen update determination module 138 may determine to update or switch a screen by applying information received from the event prioritization module 132, the user behavioral pattern learning module 134, and the user-set timer module 136 to a pattern recognition method such as machine learning.

A feature vector that is input when the screen update determination module 138 applies a pattern recognition method may be configured, as shown in the following Equation 1.

F=(F_{E1}, . . . , F_{El}, F_{T1}, . . . , F_{Tm}, F_{U1}, . . . F_{Un}) [Equation 1]

Equation 1 means that F includes the characteristic and statistical information FE sent by the event prioritization module 132, the characteristic and statistical information FT sent by the user-set timer module 136 and the characteristic and statistical information FU sent by the user behavioral pattern learning module 134, and the three pieces of information have 1 elements, m elements, and n elements, respectively.

The characteristic and statistical information sent by the event prioritization module 132 may be the number of events having been currently received, history information related to the numbers of events previously received, or statistical information related to the importance of the events having been currently received.

The characteristic and statistical information sent by the user-set timer module 136 may be the set value of a current timer, the time remaining to reach the set value, and timer completion or incompletion.

The characteristic and statistical information sent by the user behavioral pattern learning module 134 may be the average time it takes for a user to view a current screen and its standard deviation, the similarity between the pattern of current user-input information and the pattern of previous user-input information, and statistical information related to screens that have been selected by a user after the current screen was displayed.

The screen update determination module 138 may determine whether to update or switch the current screen using a pattern recognition method, and then change the corresponding screen via the screen display unit 140. That is, the screen update determination module 138 may determine whether to update or switch a current screen based on the following Equation 2:

X=M(F) [Equation 2]

In Equation 2, F is a feature vector that is used by the screen update determination module 138, M is a determination function, and X is a resulting value. M may include one or more classification functions that are used in a conventional statistical method and a conventional machine recognition method. X is a resulting value that is generated based on the feature vector F and the determination function M, and may include values indicative of whether to update a screen, whether to switch a screen, and the identifier of a subsequent screen when a current screen is changed.

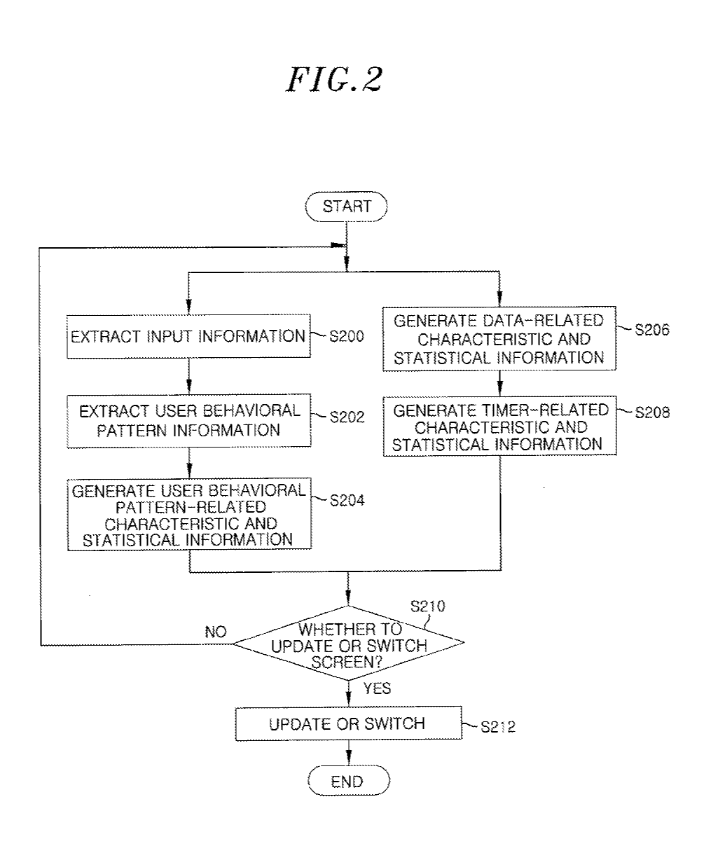

A process in which the apparatus for controlling the screen that is configured as described above updates or switches a corresponding screen will be described with reference to FIG. 2.

FIG. 2 is a flow chart showing the process of updating or switching a screen in accordance with an embodiment of the present invention.

As shown in FIG. 2, when the screen control unit 130 is operated, the screen control unit 130 iteratively extracts input information attributable to the user manipulation of a user input device via the user behavioral pattern learning module 134 in step S200, extracts user behavioral pattern information by analyzing the relationship between a current screen and a previous screen in step S202, and generates user behavioral pattern-related characteristic and statistical information by analyzing the extracted user behavioral pattern information in step S204. At the same time, the screen control unit 130 iteratively generates data-related characteristic and statistical information by analyzing newly received data via the event prioritization module 132 in step S206, and generates user-generated timer-related characteristic and statistical information via the user timer setting module 136 in step S208.

Thereafter, in step S210, the screen update determination module 138 of the screen control unit 130 determines whether to update or switch a screen based on the characteristic and statistical information that was extracted at the above steps.

If it is determined that it is necessary to update or switch the screen as a result of the determination in step S210, the screen update determination module 138 updates or switches the displayed screen via the screen display unit 140 in step S212.

On the other hand, if it is determined that it is not necessary to update or switch the screen as a result of the determination in step S210, the screen update determination module 138 returns to a start step and then performs its following steps. That is, the screen update determination module 138 continuously collects corresponding characteristic and statistical information via the event prioritization module 132, the user behavioral pattern learning module 134, and the user-set timer module 136.

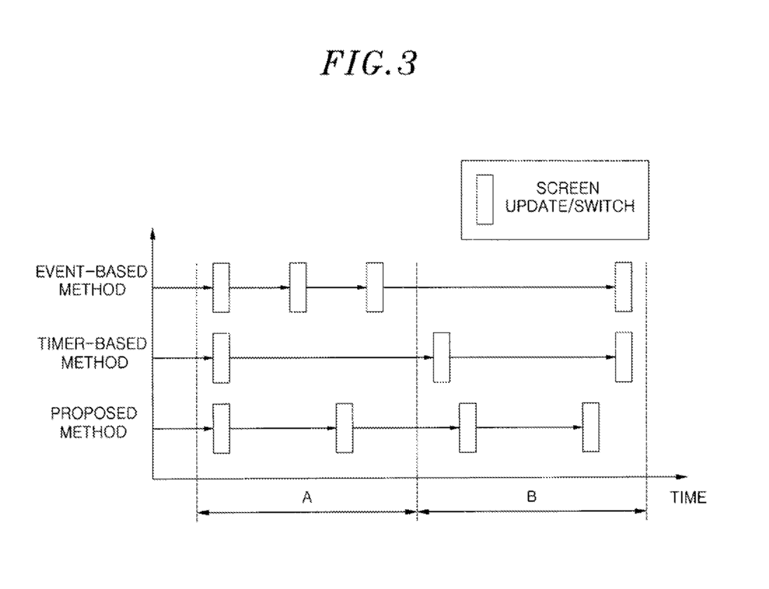

The difference between the above-described method for controlling the screen in accordance with the embodiment of the present invention and a conventional screen update method will be described with reference to FIG. 3.

Referring to FIG. 3, it can be seen that in section A in which many events occur, a screen update of an event-based method frequently occurred and a screen update of a timer-based method rarely occurred because the set time had not elapsed. In contrast, it can be seen that in the method in accordance with the embodiment of the present invention, a screen update occurred after many events had occurred and sufficient time it took for a user to interpret a screen had elapsed. Meanwhile, in section B in which an event rarely occurred, a screen update of the event-based method rarely occurred and a screen update of the timer-based method occurred when a set time had elapsed. In contrast, in the method in accordance with the embodiment of the present invention, when the sufficient time it takes for a user to interpret a screen has elapsed and data has not been received, the screen may be automatically switched from a current screen to another screen based on the pattern of the user's previous screen switches.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for controlling a screen, comprising:
a data reception unit configured to receive data and one or more events to be displayed on a screen;
a user input unit configured to provide input information attributable to manipulation of a user input device; and
a screen control unit configured to determine whether to update or switch the screen based on the events and the input information.

2. The apparatus of claim 1, wherein the screen control unit comprises:
an event prioritization module configured to determine event-related characteristic and statistical information based on a number of events having been received via the data reception unit for a preset period and a percentage of important events distributed among the events;
a user behavioral pattern learning module configured to determine user behavioral pattern-related characteristic and statistical information based on an average time it takes for a user to view each screen and its standard deviation, an average time it takes to switch between screens and its standard deviation, or a sequence frequency at which the screen is changed, by analyzing the input information attributable to the manipulation of the user input device; and
a screen update determination module configured to determine whether to update or switch the screen based on the event-related characteristic and statistical information and the user behavioral pattern-related characteristic and statistical information.

3. The apparatus of claim 2, further comprising a timer setting unit configured to provide an interface that allows a timer to be set for each screen or each component of each screen and to provide information about the timer set via the interface to the screen control unit.

4. The apparatus of claim 3, wherein:
the screen control unit further comprises a user-set timer module configured to determine operated timer-related characteristic and statistical information as the timer set via the interface is operated; and
the screen update determination module determines whether to update or switch the screen based on the event-related characteristic and statistical information, the user behavioral pattern-related characteristic and statistical information, and the timer-related characteristic and statistical information.

5. The apparatus of claim 4, wherein the screen update determination module determines whether to update or switch the screen using a machine learning pattern recognition method that uses the event-related characteristic and statistical information, the user behavioral pattern-related characteristic and statistical information, and the timer-related characteristic and statistical information as a feature vector.

6. The apparatus of claim 4, wherein the timer-related characteristic and statistical information is a set value of the timer, a time remaining to reach the set value, or completion or incompletion of the operation of the timer.

7. The apparatus of claim 2, wherein the event-related characteristic and statistical information is the number of events having been received via the data reception unit, history information related to numbers of events previously received, or statistical information related to importance of the events having been currently received.

8. The apparatus of claim 2, wherein the user behavioral pattern-related characteristic and statistical information is an average time it takes for a user to view a current screen and its standard deviation, a similarity between a pattern of current user-input information and a pattern of previous user-input information, or statistical information related to screens that have been selected by a user after a current screen was displayed.

9. The apparatus of claim 2, wherein the screen update determination module determines whether to update or switch the screen using a machine learning pattern recognition method that uses the event-related characteristic and statistical information and the user behavioral pattern-related characteristic and statistical information as a feature vector.

10. A method for controlling a screen, comprising:
receiving data and one or more events to be displayed on a screen;
generating input information attributable to manipulation of a user input device; and
determining whether to update or switch the screen based on the events and the input information.

11. The method of claim 10, wherein said determining whether to update or switch the screen comprises:
computing event-related characteristic and statistical information based on a number of events having been received for a preset period and a percentage of important events distributed among the events;
computing user behavioral pattern-related characteristic and statistical information based on an average time it takes for a user to view each screen and its standard deviation, an average time it takes to switch between screens and its standard deviation, or a sequence frequency at which the screen is changed, by analyzing the input information attributable to the manipulation of the user input device; and
determining whether to update or switch the screen based on the event-related characteristic and statistical information and the user behavioral pattern-related characteristic and statistical information.

12. The method of claim 11, further comprising:
providing an interface that allows a timer to be set for each screen or each component of each screen;
wherein said determining whether to update or switch the screen comprises:
extracting operated timer-related characteristic and statistical information as the timer set via the interface is operated; and
determining whether to update or switch the screen based on the event-related characteristic and statistical information, the user behavioral pattern-related characteristic and statistical information, and the timer-related characteristic and statistical information.

13. The method of claim 12, wherein said determining whether to update or switch the screen comprises determining whether to update or switch the screen using a machine learning pattern recognition method that uses the event-related characteristic and statistical information, the user behavioral pattern-related characteristic and statistical information, and the timer-related characteristic and statistical information as a feature vector.

14. The method of claim 12, wherein the timer-related characteristic and statistical information is a set value of the timer, a time remaining to reach the set value, or completion or incompletion of the operation of the timer.

15. The method of claim 11, wherein the event-related characteristic and statistical information is the number of events having been received via the data reception unit, history information related to numbers of events previously received, or statistical information related to importance of the events having been currently received.

16. The method of claim 11, wherein the user behavioral pattern-related characteristic and statistical information is an average time it takes for a user to view a current screen and its standard deviation, a similarity between a pattern of current user-input information and a pattern of previous user-input information, or statistical information related to screens that have been selected by a user after a current screen was displayed.

17. The method of claim 11, wherein said determining whether to update or switch the screen comprises determining whether to update or switch the screen using a machine learning pattern recognition method that uses the event-related characteristic and statistical information and the user behavioral pattern-related characteristic and statistical information as a feature vector.
